(19) United States
(12) Patent Application Publication
(10) Pub. No.: US 2010/0065728 A1
(43) Pub. Date: Mar. 18, 2010

(54) Apparatus and method for setting group of sensor node

(75) Inventors: Jae Ho Choi, Seongnam-si (KR); Kwan Joo Myoung, Suwon-si (KR)

Correspondence Address: STAAS & HALSEY LLP, SUITE 700, 1201 NEW YORK AVENUE, N.W., WASHINGTON, DC, 20005, US

(73) Assignee: SAMSUNG ELECTRONICS CO., LTD., Suwon (KR)

(21) Appl. No.: 12/461,127

(22) Filed: Jul. 31, 2009

(30) Foreign Application Priority Data
Sep. 17, 2008 (KR) 10-2008-90982

(51) Int. Cl. G01D 18/00

(52) U.S. Cl. 250/252.1

(57) ABSTRACT

An apparatus for setting a group of a sensor node and a method thereof. According to the apparatus and the method, intensity of a communication signal output from a sensor node is lowered, and the sensor node is set as a group of a master if the communication signal is received in the master, so that the sensor node can be exactly set as belonging to the group of the master.

### CROSS-REFERENCE TO RELATED APPLICATIONS

This application claims the benefit of Korean Utility Model Application No. 10-2008-0090982 filed on Sep. 17, 2008, in the Korean Intellectual Property Office, the disclosure of which is incorporated herein by reference.

### BACKGROUND

1. Field

One or more embodiments relate to an apparatus for setting a group of a sensor node and a method thereof. More particularly, one or more embodiments relate to an apparatus for setting a group of a sensor node and a method thereof, which can set a sensor node as a group of a master.

2. Description of the Related Art

A sensor network refers to a virtual network, serving as a data interface between predetermined mobile devices (i.e. sensor nodes), which are carried by a user, through short range wireless communication. Such a sensor node includes a sensor having computing power and refers to an intelligent communication device constituting the sensor network. The sensor node numerically measures physical sensor data such as the temperature, humidity, illumination and ultraviolet rays in a sensor area such that a user can receive the physical sensor data.

Meanwhile, as the number and types of the sensor nodes are remarkably increased according to needs of users, the sensor nodes are set as a group of a master to improve the energy efficiency of the sensor nodes and the reliability of data transmission, and the master collects sensor data detected by the sensor nodes to transmit the sensor data to the users.

At this time, the master sets sensor nodes, which are located in a communication area of the master and have channels and network identification identical to those of the master, as a group of the master. However, when a plurality of masters having the same channel and network identification are adjacent to each other, if a sensor node has the same channel and network identification as those of the masters, and exists in a communication area which is shared by the masters, the masters may simultaneously receive a communication signal of the sensor node and set the sensor node as a group of the masters. Thus, the sensor node may not be precisely set as a group of a master dedicated for the sensor node.

### SUMMARY

Accordingly, tone or more embodiments provide an apparatus for setting a group of a sensor node, capable of setting a sensor node as a group of a master based on a communication signal having an intensity that is lower than the normal intensity of a signal from the sensor node.

Additional aspects and/or advantages will be set forth in part in the description which follows and, in part, will be apparent from the description, or may be learned by practice of the invention.

The foregoing and/or other aspects of one or more embodiments are achieved by providing a method of setting a group of a sensor node including lowering an intensity of a communication signal output from a sensor node, and setting the sensor node as belonging to a group of a master upon the lowered intensity communication signal being received in the master.

The intensity of the communication signal output from the sensor node may be changed to a normal intensity after the sensor node is set as belonging to the group of the master.

At this time, the intensity of the communication signal output from the sensor node may be automatically changed.

Further, the intensity of the communication signal output from the sensor node may be manually changed by a user.

Meanwhile, the master may allocate a group number to the sensor node after the sensor node is set as belonging to the group of the master.

Further, the setting of the sensor node as belonging to the group of the master may be automatically performed as the sensor node is powered on.

Furthermore, the setting of the sensor node as belonging to the group of the master is manually performed by a user.

The communication signal may be a wireless signal.

The communication signal may be lowered in intensity enough to prevent reception of the communication signal by masters other then the master.

The group number may be used to confirm a sensor node when the sensor node transmits sensor data.

The manual setting of the sensor node may be performed by interfacing with the sensor node.

The sensor node may detect and transmit to and from the master sensor data including at least one of temperature, illumination, humidity, pressure, and sound.

The sensor node may be moved closer to the master to ensure that the lowered intensity communication signal is received in the master.

The normal intensity may be higher in intensity then the lowered intensity.

One or more embodiments may provide an apparatus for setting a group of a sensor node including a sensor node outputting a lower intensity communication signal while being set as belonging to a group, and a master setting the sensor node as belonging to a group thereof upon receiving the lower intensity communication signal from the sensor node.

The sensor node may change the intensity of the lower intensity communication signal to a normal intensity after the sensor node is set as belonging to the group of the master.

At this time, the intensity of the communication signal output from the sensor node may be automatically changed.

Further, the intensity of the communication signal output from the sensor node may be manually changed by a user.

Further, the setting of the sensor node as belonging to the group of the master may be automatically performed as the sensor node is powered on.

Furthermore, setting of the sensor node as belonging to the group of the master may be manually performed by a user.

The manual setting of a sensor node to belong to the group of the master may be performed through an input unit of the sensor node.

One or more embodiments may provide a method of setting a sensor node as belonging to a selected master, including decreasing a reception range of a communication signal output from the sensor node to prevent reception of the communication signal by unselected masters, and setting the sensor node as belonging to the selected master upon the communication signal being received in the selected master.

As described above, according to the apparatus for setting a group of a sensor node and the method thereof based on one or more embodiments, a sensor node, which outputs a communication signal having an intensity that is lower than normal intensity, is shifted closer to a master desired by a user for grouping, so that the sensor node can be exactly set as a group of the master.

In detail, although a sensor node having the channel and network identification identical to those of plural masters exists in a communication area shared by the masters, the sensor node can be exactly set as a group of a master desired by a user.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 illustrates an apparatus for setting a group of a sensor node according to one or more embodiments;

FIG. 2 illustrates a sensor node and a master in an apparatus for setting a group of a sensor node according to one or more embodiments;

FIG. 3 illustrates plural masters existing in a communication area between sensor nodes; and

FIG. 4 illustrates a process for setting a group of a sensor node using an apparatus, for example, the apparatus shown in FIG. 1.

### DETAILED DESCRIPTION

Reference will now be made in detail to the embodiments, examples of which are illustrated in the accompanying drawings, wherein like reference numerals refer to the like elements throughout. The embodiments are described below to explain the present invention by referring to the figures.

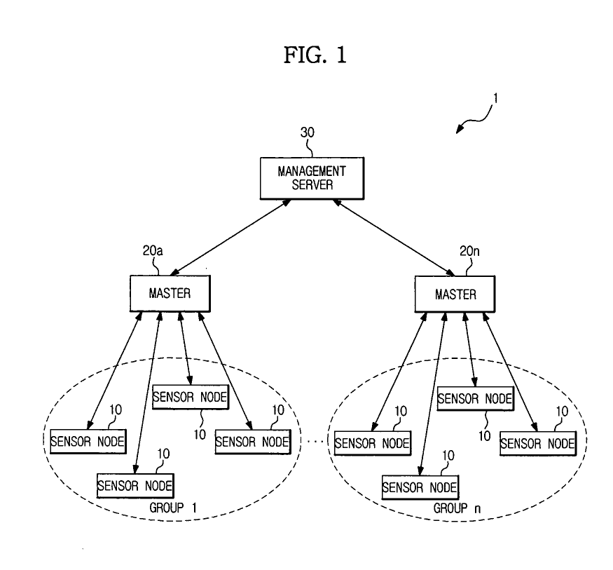

FIG. 1 illustrates an apparatus for setting a group of a sensor node according to one or more embodiments. Referring to FIG. 1, the apparatus 1 includes sensor nodes 10, one or more masters 20a and 20n, and a management server 30 for establishing and managing a sensor network using sensor data of the sensor nodes 10, which is collected by the masters 20a and 20n.

Each sensor node 10 has a physical sensing function. In detail, each sensor node 10 detects various physical quantities (i.e. sensor data), such as temperature, illumination, humidity, pressure and sound, by using a sensor mounted on the sensor node 10, and converts the sensor data into a digital signal to transmit the digital signal to the masters 20a and 20n.

Each of the masters 20a and 20n controls communication of the sensor node 10, which exists in the same network field and has been set as a group thereof (for example, GROUP 1 and GROUP n as shown in FIG. 1), and collects and integrates the sensor data of the sensor node 10 to transmit the integrated sensor data to the management server 30.

The sensor nodes 10 transmit/receive various types of data such as a control command and sensor data to/from the masters 20a and 20n through short range wireless communication. The short range wireless communication may refer to communication technology between devices in a relatively short distance such as Zigbee, Bluetooth and NFC (near field communication).

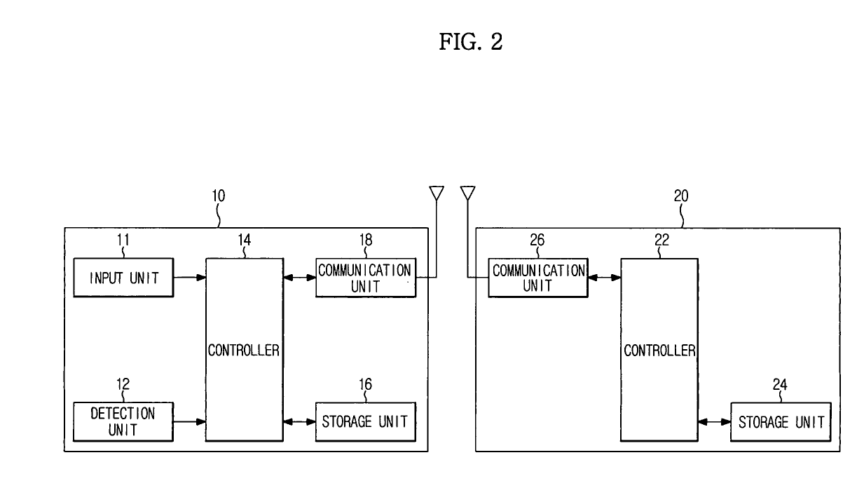

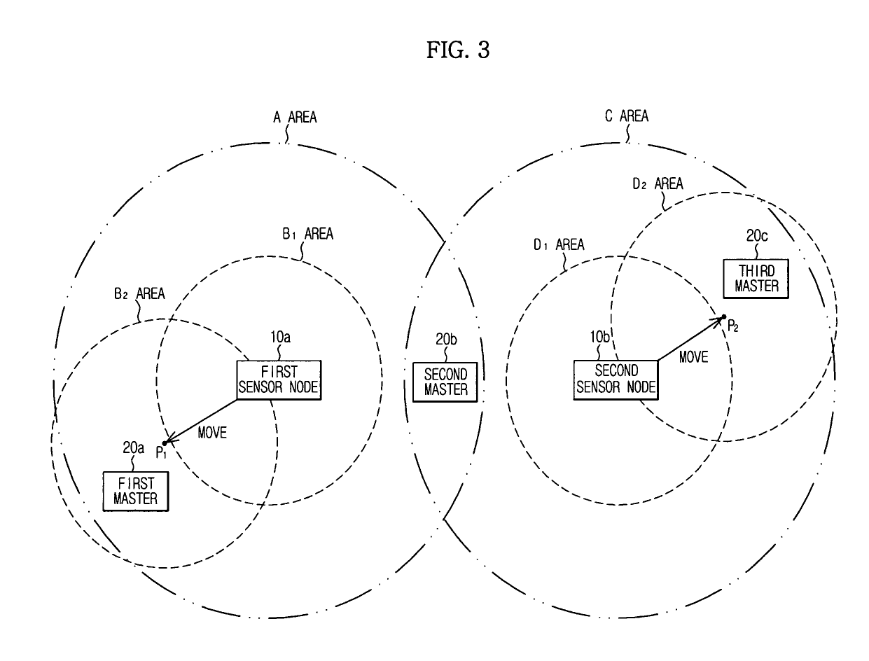

FIG. 2 illustrates the sensor node and the master in the apparatus having the above structure according to one or more embodiments, and FIG. 3 illustrates plural masters existing in a communication area between sensor nodes.

Referring to FIG. 2, the sensor node 10 includes an input unit 11, a detection unit 12, a controller 14, a storage unit 16 and a communication unit 18.

The input unit 11 is provided at an outer portion of the sensor node 10 to allow a user to input various functions of the sensor node 10 through a keypad and the like.

In detail, the input unit 11 includes a button for a group setting mode and a button for changing the intensity of a communication signal to a normal intensity, so that the group setting mode can be manually established by a user or the user can manually change the intensity of the communication signal to a normal intensity.

The detection unit 12 detects various physical quantities such as temperature, illumination, humidity, pressure and sound. For example, when the sensor node 10 detects temperature data, the detection unit 12 refers to a temperature sensor.

The controller 14 controls the general operation of the sensor node 10 and lowers the intensity of a communication signal when the sensor node 10 is to be set as a group of the master 20. In detail, the controller 14 may output an RSSI (received signal strength indicator) having an intensity lower than normal intensity so that the master 20 receiving the RSSI can set the sensor node 10 as the group thereof.

Hereinafter, a more detailed description will be given with reference to FIG. 3. When a first sensor node 10a must be set as a group of a first master 20a and a second sensor node 10b must be set as a group of a third master 20c, since plural masters (i.e. the first and second masters 20a and 20b) having channels and network identification identical to those of the first sensor node 10a exist in a communication area “A” of the first sensor node 10a, the first sensor node 10a may be set as a group of the second master 20b as well as the first master 20a.

Further, since the second and third masters 20b and 20c having channels and network identification identical to those of the second sensor node 10b exist in a communication area “C” of the second sensor node 10b, the second sensor node 10b may be set as a group of the second master 20b as well as the third master 20c.

Thus, since the first and second sensor nodes 10a and 10b may be set as groups of the masters existing in the communication areas of the first and second sensor nodes 10a and 10b through communication with the masters, the first and second sensor nodes 10a and 10b may not be exactly set as belonging to the groups of the first and third masters 20a and 20c dedicated for the first and second sensor nodes 10a and 10b, respectively.

At this time, if the controller 14 (FIG. 2) lowers intensities of communication signals output from the first and second sensor nodes 10a and 10b, the communication area “A” of the first sensor node 10a is changed to an area B₁ and the communication area “C” of the second sensor node 10b is changed to an area D₁, so that the first and second sensor nodes 10a and 10b cannot communicate with any masters.

Next, if the user moves the first sensor node 10a to a point P₁, the communication area “B₁” of the first sensor node 10a is changed to an area B₂, so that the first sensor node 10a can be set as belonging to the group of the first master 20a by communicating with the first master 20a. Further, if a user moves the second sensor node 10b to a point P₂, the communication area “D₁” of the second sensor node 10b is changed to an area D₂, so that the second sensor node 10b can be set as belonging to the group of the third master 20c by communicating with the third master 20c.

As described above, the user moves the first and second sensor nodes 10a and 10b closer to the masters desired by the user for grouping, so that the first and second sensor nodes 10a and 10b can be exactly set in the groups of the masters dedicated for the first and second sensor nodes 10a and 10b, respectively.

Referring to FIGS. 2 and 3, meanwhile, before the sensor node 10a is set as belonging to the group of the master 20a, a process of establishing a group setting mode must be performed. If the sensor node 10a is powered on, the controller 14 controls the group setting mode to be automatically established. Further, if the user presses an input button for the group setting mode through the input unit 11, the controller 14 controls the group setting mode to be established.

Further, the controller 14 sets the sensor node 10a as belonging to the group of the master 20a and then controls the communication signal to have a normal intensity.

At this time, the intensity of the communication signal may be automatically changed by the controller 14 or may be manually changed by the user. In the case of an automatic change, if the sensor node 10a is set as belonging to the group of the master 20a, the controller 14 automatically changes the intensity of the communication signal to a normal intensity.

In the case of manual change, if the user presses the input button for changing the intensity of the communication signal to the normal intensity through the input unit 11, the controller 14 controls the communication signal to have the normal intensity.

The storage unit 16 stores specific identification information, channel information and network identification of the sensor node 10.

The specific identification information of the sensor node 10 refers to information for identifying the sensor node 10, the channel information refers to information for a channel used by the sensor node 10, and the network identification is used when the sensor node. 10 performs network communication. Accordingly, a storage unit 16 refers to a storage medium capable of storing the specific identification information, the channel information and the network identification of the sensor node 10, and may include any of a DRAM (direct random access memory), an SDRAM (synchronous DRAM), an RDRAM (rambus DRAM), a DDRAM (double rate DRAM) and an SRAM (static random access memory).

The communication unit 18 transmits sensor data detected by the detection unit 12 to the master 20a, which sets the sensor node 10a as belonging to the group thereof, or transmits/receives a communication signal to/from the master 20a.

Hereinafter, a controller 22, a storage unit 24 and a communication unit 26 constituting each of the masters 20a and 20c will be described.

The controller 22 controls the general operation of each of the masters 20a and 20c, and sets the sensor node 10a or 10b, for example, as belonging to a group thereof upon receiving the communication signal from the sensor node 10a or 10b, for example, through the communication unit 26 in the group setting mode.

Then, the controller 22 allocates a group number to the sensor node 10a or 10b. For example, the controller 22 allocates a group number 1 to the sensor node 10a of the master 20a and allocates a group number 2 to the sensor node 10b of the master 20c, thereby allowing the management server 30 to easily confirm the sensor nodes 10 when receiving the sensor data.

The storage unit 24 stores specific identification information, channel information and network identification and stores the specific identification information of a sensor node 10 which has been set as a group of a corresponding master. As described above, the storage unit 24 stores the specific identification information of the sensor node 10 which has been set as belonging to the group of the corresponding master, so that the corresponding master can continuously communicate with the sensor node 10.

The communication unit 26 receives the communication signal and sensor data from the sensor node 10 or transmits a signal representing that group setting for the sensor node 10 has been completed.

Hereinafter, a process for setting a group of a sensor node using, for example, the apparatus having the above structure will be described.

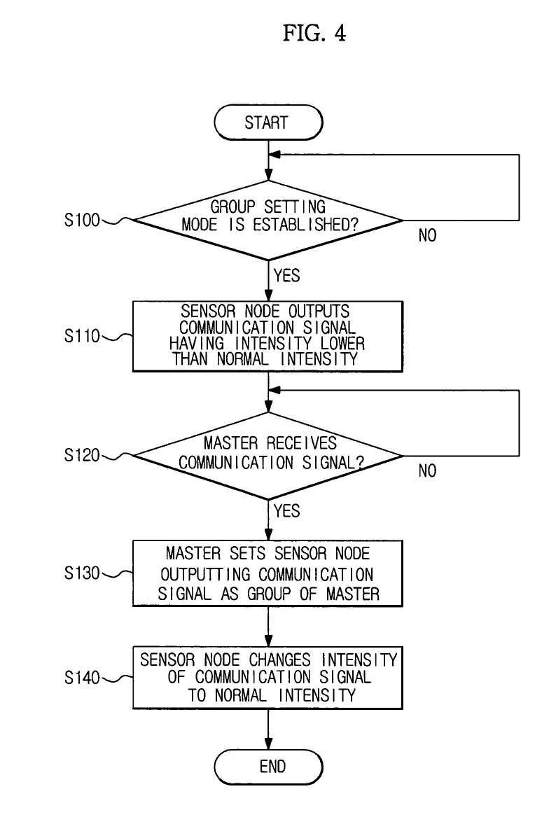

FIG. 4 illustrates the process for setting a group of a sensor node using the apparatus having the above structure according to one or more embodiments.

Referring to FIGS. 2 and 4, it is determined if the group setting mode is established in the sensor node 10 (S100). At this time, the group setting mode can be automatically established as the sensor node 10 is powered on, or the group setting mode can be manually established when a user presses the button for the group setting mode, which is provided at the outer portion of the input unit 11 of the sensor node 10.

If the group setting mode is established in S100, the sensor node 10 outputs a communication signal having intensity lower than normal intensity S110. If the group setting mode is not established in S100, the process may repeat step S100 until a group setting mode is established.

Next, referring to FIGS. 3 and 4, the user moves the first and second sensor nodes 10a and 10b to the points P₁ and P₂ in order to allow the first and second sensor nodes 10a and 10b to be set as belonging to the groups of the first and third masters 20a and 20c dedicated for the first and second sensor nodes 10a and 10b, respectively. Then, the first and third masters 20a and 20c determine if the communication signals are received from the first and second sensor nodes 10a and 10b through the communication units 26 thereof S120.

If the communication signals are received from the first and second sensor nodes 10a and 10b in S120, the first and third masters 20a and 20c set the first and second sensor nodes 10a and 10b to output the communication signals as belonging to the groups thereof, respectively S130. If the communication signals are not received from the first and second sensor nodes 10a and 10b in S120, the process may repeat step S120 until the master receives a communication signal.

As described above, the reason for lowering the intensity of the communication signal output from the sensor node 10a below the normal intensity is as follows. When the master 20b, which has the channel and network identification identical to those of the sensor node 10a, is adjacent to the master 20a, which has the channel and network identification identical to those of the master 20a, if the sensor node 10a outputs the communication signal having the normal intensity, the master 20b may receive the communication signal to perform a grouping operation relative to the sensor node 10a. Thus, the intensity of the communication signal output from the sensor node 10a must be lowered. Further, the sensor node 10a outputting the communication signal having the lower intensity must be shifted closer to the master 20a such that the sensor node 10a can be exactly set as belonging to the group of the master 20a.

After the corresponding master sets the sensor node 10a as belonging to the group thereof in S130, the sensor node 10a changes the intensity of the communication signal to a normal intensity S140. In detail, the intensity of the communication signal can be automatically changed to the normal intensity or the intensity of the communication signal can be manually changed to the normal intensity by a user.

Then, if the intensity of the communication signal of the sensor node is changed to the normal intensity after the group setting, the user may relocate the sensor node 10a to a desired position.

Further, the sensor node, for example, sensor node 10a, establishes a sensor network by continuously transmitting/receiving sensor data to/from the master, for example, master 20a, which has set the sensor node 10a as the group thereof. In detail, since the master 20a stores the specific identification information of the sensor node 10a, the master 20a can continuously communicate with the sensor node 10a using the specific identification information of the communication signal output from the sensor node 10a.

In addition to the above described embodiments, one or more embodiments may also be implemented through computer readable code/instructions in/on a medium, e.g., a computer readable medium, to control at least one processing element to implement any above described embodiment. The medium can correspond to any medium/media permitting the storing or transmission of the computer readable code.

The computer readable code can be recorded on a medium in a variety of ways, with examples of the medium including recording media, such as magnetic storage media (e.g., ROM, floppy disks, hard disks, etc.) and optical recording media (e.g., CD-ROMs, or DVDs). The computer readable code may also be transmitted through transmission media. Thus, the medium may be such a defined and measurable structure carrying or controlling a signal or information, such as a device carrying a bitstream, for example. The media may also be a distributed network, so that the computer readable code is stored/transferred and executed in a distributed fashion. Still further, as only an example, the processing element could include a processor or a computer processor, and processing elements may be distributed and/or included in a single device.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. A method of setting a group of a sensor node, the method comprising:
lowering an intensity of a communication signal output from a sensor node; and
setting the sensor node as belonging to a group of a master upon the lowered intensity communication signal being received in the master.

2. The method as claimed in claim 1, wherein the intensity of the communication signal output from the sensor node is changed to a normal intensity after the sensor node is set as belonging to the group of the master.

3. The method as claimed in claim 2, wherein the intensity of the communication signal output from the sensor node is automatically changed.

4. The method as claimed in claim 2, wherein the intensity of the communication signal output from the sensor node is manually changed.

5. The method as claimed in claim 1, wherein the master allocates a group number to the sensor node after the sensor node is set as belonging to the group of the master.

6. The method as claimed in claim 1, wherein the setting of the sensor node as belonging to the group of the master is automatically performed as the sensor node is powered on.

7. The method as claimed in claim 1, wherein the setting of the sensor node as belonging to the group of the master is manually performed.

8. The method as claimed in claim 1, wherein the communication signal is lowered in intensity enough to prevent reception of the communication signal by masters other then the master.

9. The method as claimed in claim 5, wherein the group number is used to confirm a sensor node when the sensor node transmits sensor data.

10. The method as claimed in claim 7, wherein the manual setting of the sensor node is performed by interfacing with the sensor node.

11. The method as claimed in claim 1, wherein the sensor node detects and transmits to and from the master sensor data including at least one of temperature, illumination, humidity, pressure, and sound.

12. The method as claimed in claim 1, wherein in the sensor node is moved closer to the master to ensure that the lowered intensity communication signal is received in the master.

13. An apparatus for setting a group of a sensor node, the apparatus comprising:
a sensor node outputting a lower intensity communication signal while being set as belonging to a group; and
a master setting the sensor node as belonging to a group thereof upon receiving the lower intensity communication signal from the sensor node.

14. The apparatus as claimed in claim 13, wherein the sensor node changes the intensity of the lower intensity communication signal to a normal intensity after the sensor node is set as belonging to the group of the master.

15. The apparatus as claimed in claim_14, wherein the intensity of the communication signal output from the sensor node is automatically changed.

16. The apparatus as claimed in claim 14, wherein the intensity of the communication signal output from the sensor node is manually changed.

17. The apparatus as claimed in claim 13, wherein the setting of the sensor node as belonging to the group of the master is automatically performed as the sensor node is powered on.

18. The apparatus as claimed in claim 13, wherein the setting of the sensor node as belonging to the group of the master is manually performed.

19. The apparatus as claimed in claim 18, wherein the manual setting of a sensor node to belong to the group of the master is performed through an input unit of the sensor node.

20. A method of setting a sensor node as belonging to a selected master, the method comprising:
decreasing a reception range of a communication signal output from the sensor node to prevent reception of the communication signal by unselected masters; and
setting the sensor node as belonging to the selected master upon the communication signal being received in the selected master.
